(19) United States
(12) Patent Application Publication
(10) Pub. No.: US 2008/0153546 A1
(43) Pub. Date: Jun. 26, 2008

(54) METHODS AND APPARATUSES FOR SIM APPLICATION TOOLKIT (SAT) MANAGEMENT

(75) Inventors: Arun Gupta, Faridabad (IN); Sachin Jain, Saharanpur (IN); Puneet Dutt, Meerut (IN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INDIA TECHNOLOGY PVT. LTD., Noida (U.P.) (IN)

(21) Appl. No.: 11/876,034

(22) Filed: Oct. 22, 2007

(30) Foreign Application Priority Data
Dec. 21, 2006 (IN) 2764/DEL/2006

(51) Int. Cl. H04B 1/38

(52) U.S. Cl. 455/558

(57) ABSTRACT

An embodiment of a method for subscriber identity module (SIM) application toolkit (SAT) management, performed by a processing unit of a mobile station, is provided. A SAT shortcut to a SAT final node, or to a sub-menu including the SAT final node, is created. A value-added service (VAS) provided by a SAT application of a remote server is requested when selecting the SAT shortcut to the SAT final node. The sub-menu is displayed when selecting the SAT shortcut to the sub-menu.

### BACKGROUND

The invention relates to subscriber identity modules (SIM), and more particularly, to methods and systems for SIM application toolkit (SAT) management.

SIM cards are smart cards containing account information, such as telephone number, user name, or others, inserted into global system for mobile communication (GSM) phones. SIM cards can also be programmed to store customer menus. SAT is a widely used value added service (VAS) technology. SAT is a set of commands defining how SIM cards interact with a communications network. SAT also extends the communication protocol between SIM card and the GSM phone. With SAT, a SIM card can initiate a command independently of a GSM phone and GSM network.

### SUMMARY

An embodiment of a method for subscriber identity module (SIM) application toolkit (SAT) management, performed by a processing unit of a mobile station, is provided. A SAT shortcut to a SAT final node, or to a sub-menu comprising the SAT final node, is created. A value-added service (VAS) provided by a SAT application of a remote server is requested when selecting the SAT shortcut to the SAT final node. The sub-menu is displayed when selecting the SAT shortcut to the sub-menu.

An embodiment of an apparatus for SAT management is provided, comprising a display device and a processing unit. The processing unit, coupling to the display device, creates a SAT shortcut to a SAT final node, or to a sub-menu comprising the SAT final node, requests a VAS provided by a SAT application of a remote server when selecting the SAT shortcut to the SAT final node, and displays the sub-menu on the display device when selecting the SAT shortcut to the sub-menu.

An embodiment of a method for SAT management, performed by a processing unit of a mobile station, is provided. A menu traversal path is received. A SAT shortcut triggering procedure emulating traversal behavior of man-machine interface (MMI) operation corresponding to the menu traversal path is performed in background in order to issue a SAT command to a SAT application of a remote server to acquire a particular VAS, or display a menu list.

An embodiment of an apparatus for SAT management is provided, comprising a SIM, a nonvolatile memory and a processing unit. The nonvolatile memory stores a menu traversal path. The processing unit coupling to the nonvolatile memory performs a SAT shortcut triggering procedure emulating traversal behavior of MMI operation corresponding to the menu traversal path in background in order to issue a SAT command to a SAT application of a remote server to acquire a VAS via the SIM, or acquire a menu list from the SIM and display the menu list.

### BRIEF DESCRIPTION OF THE DRAWINGS

The invention can be more fully understood by reading the subsequent detailed description and examples with references made to the accompanying drawings, wherein:

FIG. 1 is a diagram of an embodiment of a SAT management system;

FIG. 2 is a diagram of a hardware environment applicable to a mobile phone;

FIG. 3 is a flowchart illustrating an embodiment of a method for SAT shortcut configuration;

FIG. 4 is a diagram an embodiment of a mobile phone;

FIG. 5a is a diagram of an exemplary dialog box for entering a name for the created SAT shortcut;

FIG. 5b is a diagram of an exemplary selection menu for mapping the created SAT shortcut to a hard key;

FIGS. 6a to 6f are diagrams of exemplary menus at different times with reference to FIG. 3;

FIG. 7 is a flowchart illustrating execution of shortcut triggering procedures;

FIG. 8 is a flowchart illustrating an embodiment of a SAT shortcut triggering procedure;

FIG. 9 is a diagram illustrating the menu structure for configuring and periodically acquiring real-time football scores;

FIG. 10 is a sequence diagram illustrating periodically acquiring real-time football scores from a server.

### DETAILED DESCRIPTION

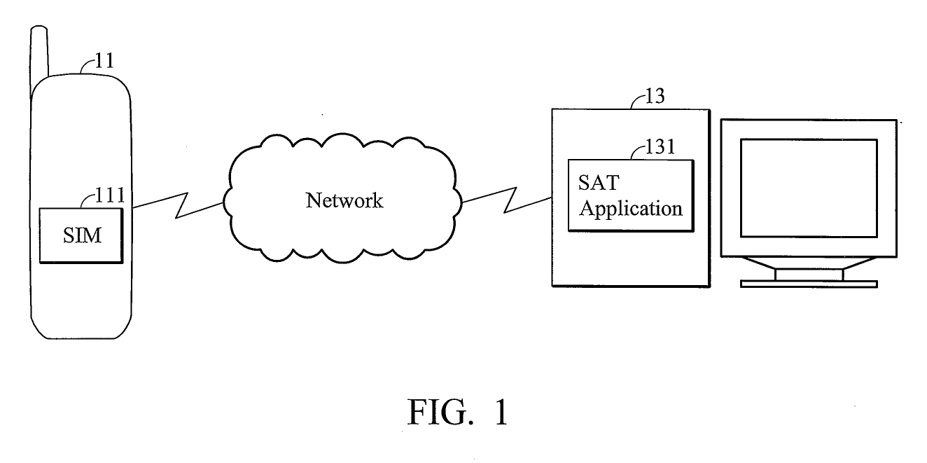

The subscriber identity module (SIM) application toolkit (commonly referred to as SAT) is a GSM standard enabling SIM cards to initiate actions for various value added services. The SAT consists of a set of commands programmed into a SIM card. The programmed commands define the ways in which a SIM card can interact directly with a communications network and initiate commands independently of a mobile phone and the network. SAT allows the SIM to build an interactive exchange between a network SAT application of a remote sever and the end user and access or control access to the network. FIG. 1 is a diagram of an embodiment of a SAT management system comprising a mobile phone 11 equipped with a SIM 111, and a server 13 running SAT application 131. SAT application 131 may serve services of real-time news, stock prices, sports scores, and others. The mobile phone 11 communicates with the server 13 via the network. The SIM comprises modules capable of initiating SAT commands, and a SAT menu. Those skilled in the art will recognize that the mobile phone 11 and server 13 may be connected in different types of networking environments, and may communicate through various transmission devices such as routers, gateways, access points, base station systems and others.

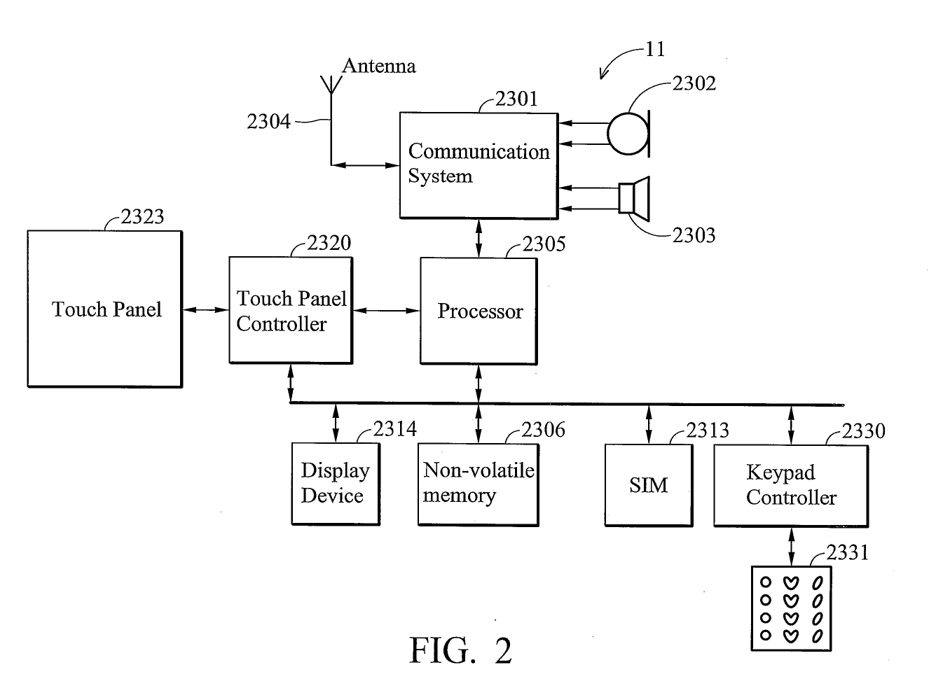

FIG. 2 is a diagram of a hardware environment applicable to the mobile phone 11 mainly comprising a communication system 2301, a microphone 2302, a speaker 2303, an antenna 2304, a processor 2305, non-volatile memory 2306, a display device 2314, a SIM 2313, a touch panel controller 2320, and a keypad controller 2330. The communication system 2301 communicates with the server 13 (FIG. 1) via the antenna 2304 when connecting to a cellular network, such as global system for mobile communications (GSM), general packet radio service (GPRS), enhanced data rates for global evolution (EDGE), code division multiple access (CDMA), wideband code division multiple access (WCDMA) or circuit switched data (CSD) system or similar. The processor 2303 connects to the display device 2314, non-volatile memory 2306, SIM 2313, touch panel controller 2320, and keypad controller 2330 via various bus architectures. The touch panel controller 2320 connects to a touch panel 2323 to receive user input, such as, click, double-click and drag-and-drop signals respectively from relevant regions, such as soft keys, on the touch panel 2323. The touch panel controller 2320 and the touch panel 2323 in the mobile phone 11 can be omitted according to requirements for reducing hardware cost. The keypad controller 2330 is connected to and receives keystroke signals from a keypad 2331.

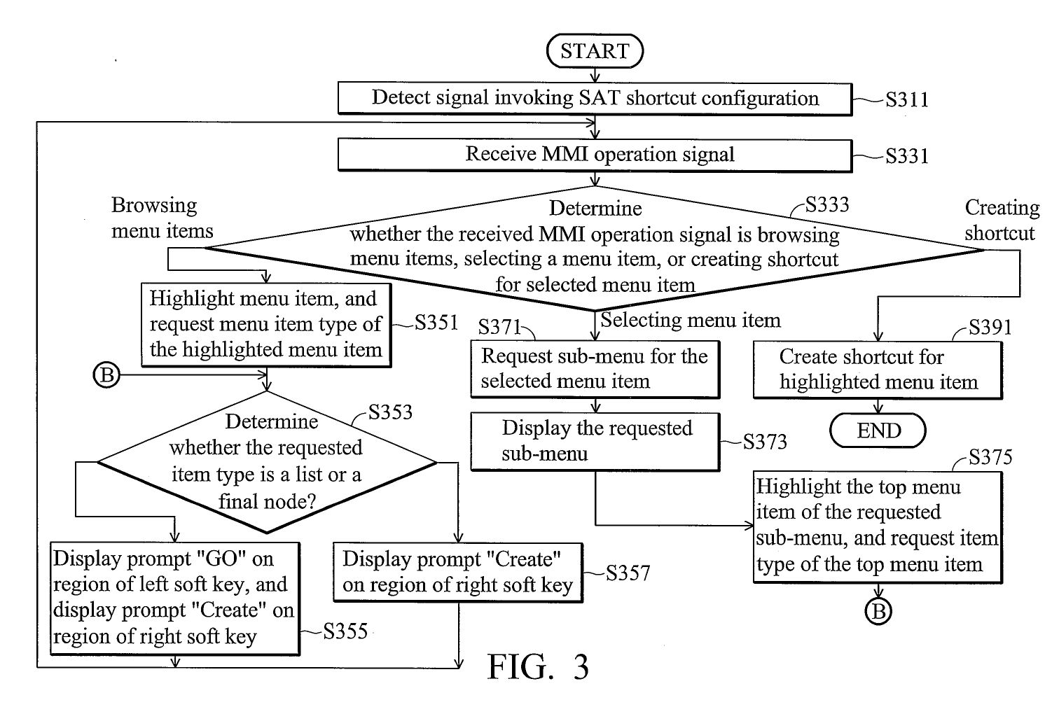

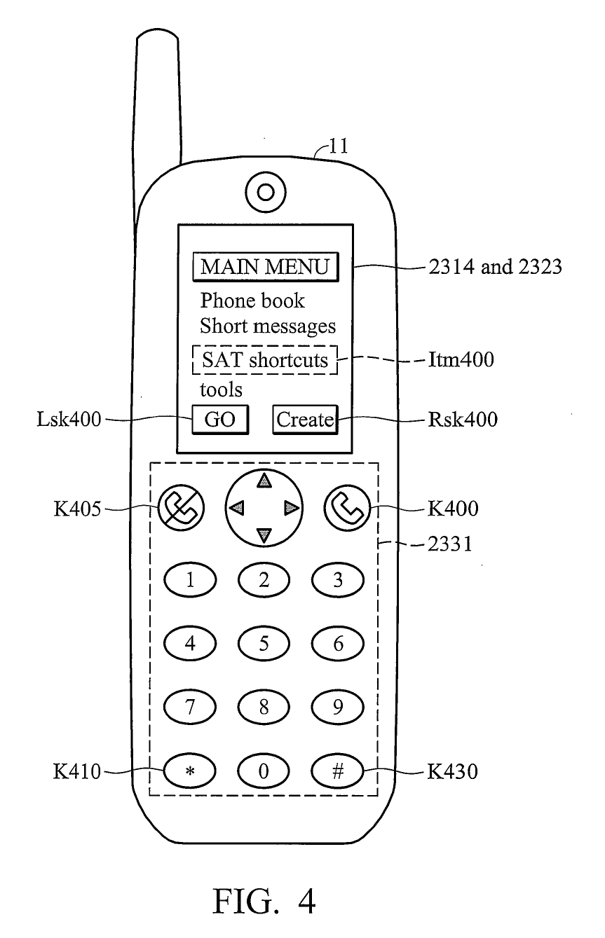

FIG. 3 is a flowchart illustrating an embodiment of a method for SAT shortcut configuration, performed by the processor 2305 (FIG. 2). In step S311, a signal invoking a SAT shortcut configuration is detected. The SAT shortcut configuration may be provided via man-machine interface (MMI) operation. FIG. 4 is a diagram an embodiment of the mobile phone 11 comprising the display device 2314, the touch panel 2323, and the keypad 2331. The keypad 2331 comprises certain hard keys, such as K400, K405, K410, K430 or others. The display device 2314 displays an exemplary main menu comprising a menu item Itm400 labeled “SAT shortcuts”. With highlighting menu item Itm400, the processor 2305 detects a signal invoking a SAT shortcut configuration when a keystroke signal of a hard key K400 is detected via the keypad controller 2330 (FIG. 2), or a double-click signal from a soft key Lsk400 on the touch panel 2323 is detected via the touch panel controller 2320.

Referring to FIG. 3, in step S331, an MMI operation signal is received from the touch panel controller 2320 or keypad controller 2330. In step S333, it is determined whether the received MMI operation signal is browsing menu items, selecting a menu item, or creating shortcut for a selected menu item. It is to be understood that operations for browsing menu items and selecting a menu item are commonly referred to as traversal operations of a menu. The process proceeds to step S351 when browsing menu items, to step S371 when selecting a menu item, and to step S391 when creating a shortcut for a selected menu item. The processor 2305 may determine that the received MMI operation signal indicates browsing menu items when detecting a keystroke signal of a up arrow key or a down arrow key via the keypad controller 2330 (FIG. 2), or a click signal from a region displaying menu items via the touch panel controller 2320 (FIG. 2). The processor 2305 may determine the received MMI operation signal to be selection of a menu item when a signal is received from hard key K405 of keypad controller 2330 (FIG. 4). A click signal from a soft key “GO” of a region of touch panel controller 2320 such as Lsk400 (FIG. 4) may be interpreted as selection of a menu item. Similarly, a double click signal from a region displaying a list of menu items via the touch panel controller 2320 may be interpreted as selection of a menu item. The processor may determine that the received MMI operation signal is creation of a shortcut of a selected menu item when detecting a click signal from a region displaying a soft key labeled “Create”, such as Rsk400 (FIG. 4).

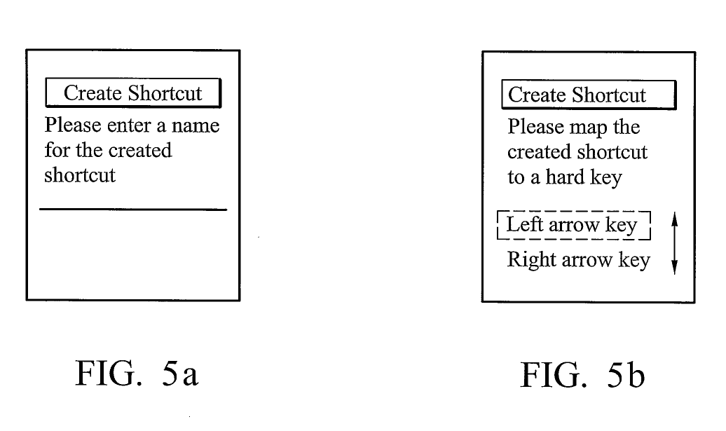

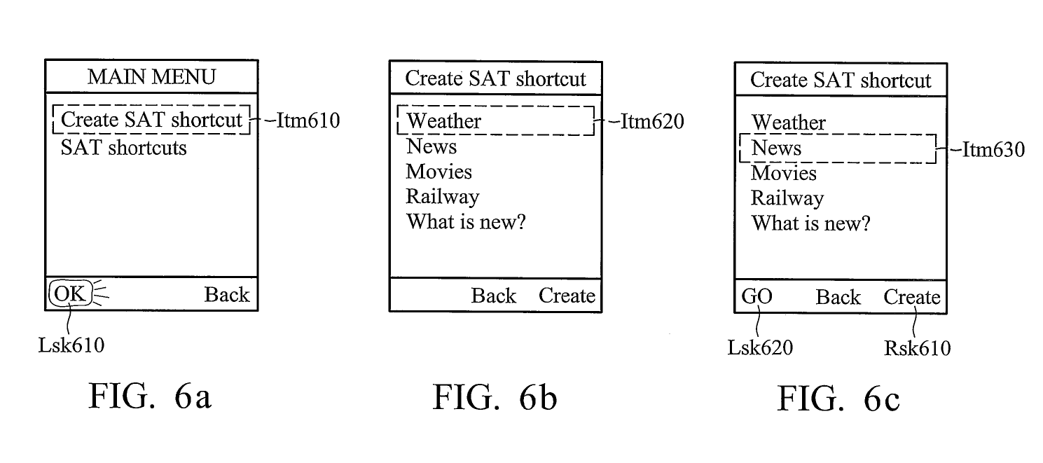

In step S351, a menu item is highlighted, and a menu item type of the highlighted menu item is requested from the SIM 2313 (FIG. 2). The SIM 2313 responds with a menu item type of the browsed menu item, such as a list, a final node or others. In step S353, it is determined whether the requested item type is a list or a final node. When the requested item type is a list, the process proceeds to step S355, otherwise, to step S357. The requested item type being a list indicates that the browsed menu item relates to a menu comprising one or more menu items, referred to as a sub-menu entry. The requested item type being a final node indicates that the browsed menu item relates to no additional menus, and may correspond to at least one SAT command for requesting a particular value added service (VAS) provided by the SAT application 131 of the server 13 (FIG. 1). In step S355, a prompt “GO” is displayed on a region of a left soft key, and a prompt “Create” is displayed on a region of a right soft key. In step S357, a prompt “Create” is displayed on a region of a right soft key. In step S371, a menu (also called a sub-menu) for the selected menu item is requested by issuing a request to the SIM 2313. The SIM 2313 subsequently responds with a menu comprising menu items for the selected menu item. The tree structure of a menu for SAT shortcut configuration may be pre-stored in a SIM card of the SIM 2313. In step S373, the requested sub-menu is displayed on the display device 2314 (FIG. 4). In step S375, the top menu item of the requested sub-menu is highlighted, and an item type of the top menu item is requested by issuing a request to the SIM 2313. Subsequent to step S375, the process proceeds to steps 353, and S355 or S357 for displaying prompts on regions of a left soft key and a right soft key. In step S391, a shortcut for a highlighted menu item is created. In step S391, a dialog box may be displayed on the display device 2314 for input of a name for the created SAT shortcut. The created SAT shortcut may be represented in a shortcut string such as “News→Sports” with a delimiter “→”, and the string is stored in the non-volatile memory 2396 (FIG. 2). It is to be understood that the created shortcut string may be represented in different but similar representations such as a menu traversal path “2;3” with a delimiter “;”, each delimited number represents a hierarchical SAT menu item number, indicating a third item of a second menu list in a SAT menu. Note that the delimited sub-string such as “News” or “Sports”, or the delimited number such as “2” or “3”, may be referred as an identifier to a specific SAT menu item. FIG. 5a is a diagram of an exemplary dialog box for inputting a name of the created SAT shortcut. The processor 2305 may insert a new menu item with the input name into a SAT shortcut list menu in the non-volatile memory 2306. Thereafter, when the newly created menu item of the SAT shortcut list menu is selected, the processor 2305 may request a particular VAS provided by the SAT application 131 of the server 13 (FIG. 1), or display a SAT menu relating to the created SAT shortcut. In step S391, the processor 2305 may provide a menu on the display device 2314 to facilitate mapping to the created SAT shortcut to a hard key. FIG. 5b is a diagram of an exemplary selection menu for mapping the created SAT shortcut to a hard key. Those skilled in the art may recognize that an idle screen is displayed to reduce power consumption after determining that no input signals have been detected for a predetermined amount of time. Thereafter, when displaying the idle screen and detecting a keystroke signal of the mapped hard key, the processor 2305 stops displaying the idle screen, and may request a particular VAS provided by the SAT application 131 of the server 13, or display a SAT menu relating to the created SAT shortcut according to a corresponding shortcut string in the non-volatile memory 2396. Those skilled in the art may realize that the issued SAT command may be encapsulated in a mobile phone call, a short message (SM), an unstructured supplementary service data (USSD), or similar.

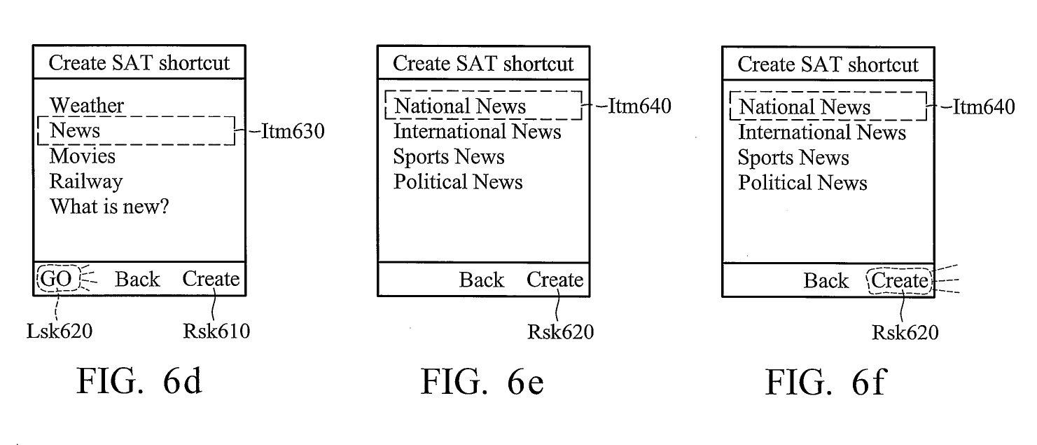

Detailed descriptions of examples for SAT shortcut configuration are provided. FIGS. 6a to 6f are diagrams of exemplary menus at different times with reference to FIG. 3. Referring to FIG. 6a, a main menu comprising two menu items is initially provided, where a menu item Itm610 is labeled by “Create SAT shortcut”, and the other is labeled by “SAT shortcuts”. The menu item “SAT shortcuts” that the item type of which is a list relates to a menu containing at least one user created shortcut. When the menu item Itm610 is highlighted and a region of a left soft key Lsk610 is clicked, the processor 2305 detects a signal invoking a SAT shortcut configuration (step S311 of FIG. 3). After detecting a signal invoking a SAT shortcut configuration, a menu for SAT shortcut creation is displayed. Referring to FIG. 6b, the menu for SAT shortcut creation initially highlights the top menu item labeled “Whether” Itm620. When detecting an MMI operation signal indicating browsing a lower menu item (steps S331 and S333 of FIG. 3), referring to FIG. 6c, the browsed menu item labeled “News” Itm630 is highlighted, and an item type of the browsed menu item Itm630 is requested by issuing a request to the SIM 2313 (FIG. 2). When determining that the requested item type is a list (step S353 of FIG. 3), a prompt “GO” is displayed on a region of a left soft key LSK620, and a prompt “Create” is displayed on a region of a right soft key RSK610.

Referring to FIG. 6d, when the menu item Itm630 is highlighted and the region of the left soft key Lsk620 is clicked, the processor 2305 detects a signal indicating that the menu item Itm630 is selected (step S333 of FIG. 3). After detecting a signal indicating that the menu item Itm630 is selected, referring to FIG. 6e, a sub-menu relating to the selected menu item Itm630 is requested by issuing a request to the SIM 2313 (step S371 of FIG. 3), the requested sub-menu is displayed (step S373 of FIG. 3), the top menu item of the requested sub-menu Itm640 is highlighted, and an item type of the top menu item Itm640 is requested by issuing a request to the SIM 2313 (step S375 of FIG. 3). Subsequently, after determining that the request item type is a final node (step S353 of FIG. 3), a prompt “Create” is displayed on a region of a right soft key RSK620 (step S357 of FIG. 3). Referring to FIG. 6f, when the menu item Itm640 is highlighted and the region of the right soft key Rsk620 is clicked, the processor 2305 detects a signal indicating that a shortcut to the menu item Itm640 is created (step S333 of FIG. 3). After detecting a signal indicating that a shortcut to the menu item Itm640 is created, a name for the created SAT shortcut may be input via a dialog box (referring to FIG. 5a). The processor 2305 may insert a new menu item with the input name into a SAT shortcut list menu in the non-volatile memory 2306. Thereafter, when the newly created menu item of the SAT shortcut list menu is selected, the processor 2305 requests and displays national news provided by the SAT application 131 of the server 13. For example, referring to FIG. 6a, when highlighting a menu item labeled “SAT shortcuts” and clicking the left soft key LSK610, a SAT shortcut list menu comprising the newly created menu item is displayed. Alternatively, after detecting a signal indicating that a shortcut to the menu item Itm640 is created, a hard key may be mapped to the created SAT shortcut via a selection menu (referring to FIG. 5b). Thereafter, when displaying the idle screen and detecting a keystroke signal of the mapped hard key, the processor 2305 stops displaying the idle screen, requests and displays national news provided by the SAT application 131 of the server 13.

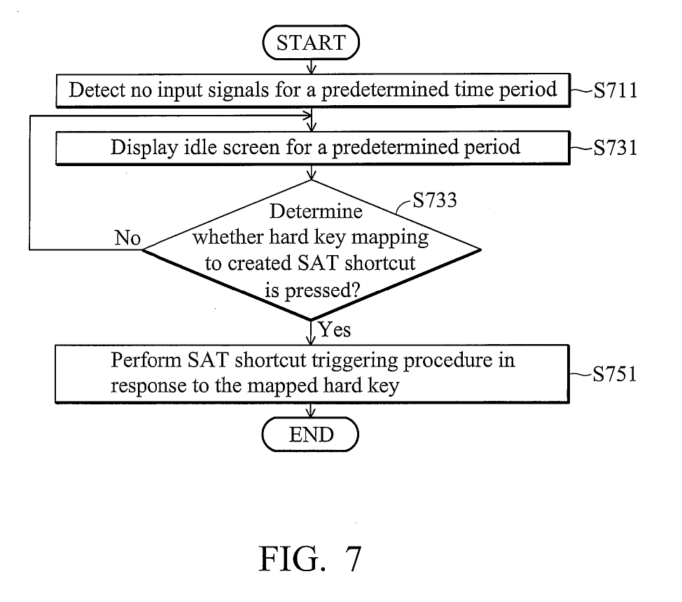

FIG. 7 is a flowchart illustrating execution of shortcut triggering procedures when the mobile phone 11 (FIG. 2) enters a power saving mode, performed by the processor 2305 (FIG. 2). In step S711, no input signals are detected for a predetermined time period. The input signals may comprise keystroke signals detected via the keypad controller 2330 (FIG. 2), click, double-click, and drag-and-drop signals detected via the touch panel controller 2320, and an incoming call request detected via the communication system 2301 (FIG. 1). A power saving mode is entered when input signals are not detected for a predetermined period. In step S731, an idle screen is displayed for a predetermined period to reduce power consumption. Subsequently, step S733 is repeatedly executed to determine whether a hard key mapping to a created SAT shortcut is pressed. If so, the process proceeds to step S731, otherwise, to step S751. In step S751, a SAT shortcut triggering procedure in response to the mapped hard key is performed. The SAT shortcut triggering procedure may request a particular VAS provided by the SAT application 131 of the server 13 (FIG. 1), such as periodically requesting real-time sports scores, stock quotes, news, weather, or others, or display a SAT menu relating to the created SAT shortcut.

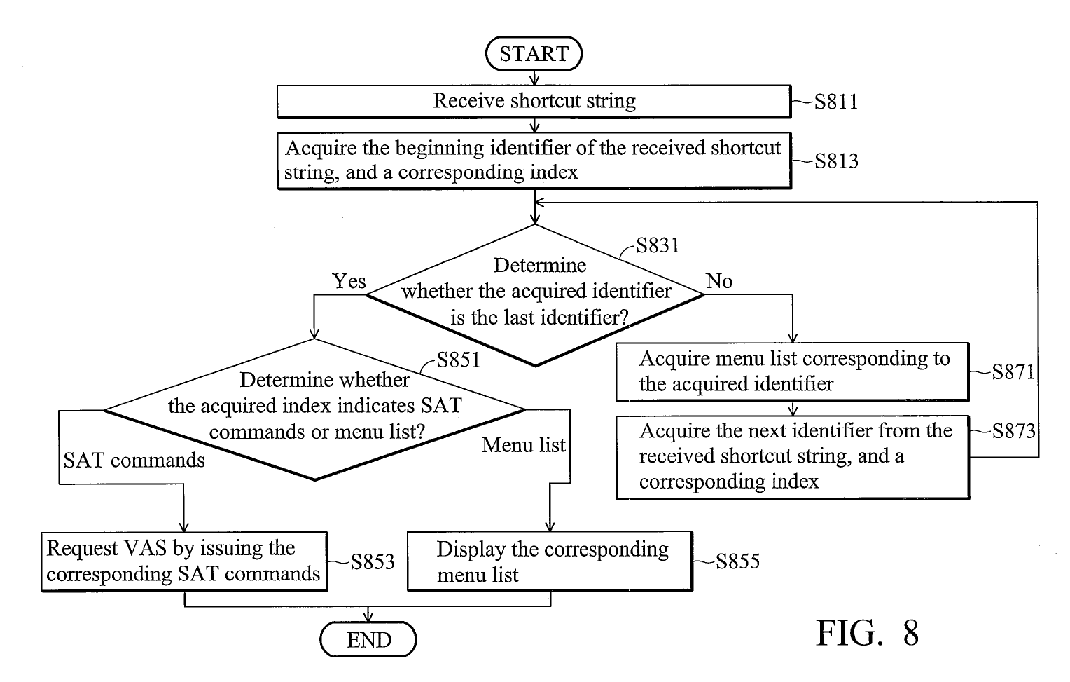

FIG. 8 is a flowchart illustrating an embodiment of a SAT shortcut triggering procedure applied in step S751 (FIG. 7), performed by the processor 2305 (FIG. 2). In step S811, a shortcut string is acquired from the non-volatile memory 2306 (FIG. 2). In step S813, a top-level SAT menu list comprising multiple identifiers each with an index is acquired by requesting the SIM 2313, a beginning identifier is acquired from the received shortcut string, and an index corresponding to the beginning identifier is acquired from the top-level SAT menu list. After that, a loop comprising steps S831, S851, S853, S855, S871 and S873 is repeatedly performed until that the last identifier is completely processed. In step S831, it is determined whether the acquired identifier is the last one. If so, the process proceeds to step S851, otherwise, to step S871. In step S851, it is determined whether the acquired index indicates SAT commands or a menu list. If the acquired index corresponds to SAT commands, the process proceeds to step S853, otherwise, to step S855. In step S853, a series of SAT commands indicated by the acquired index are issued to the SAT application 131 of the server 13 by requesting the SIM 2313 (FIG. 2) in order to request a particular VAS therein. In step S855, a menu list indicated by the acquired index is acquired by requesting the SIM 2313, and the acquired menu list is displayed on the display device 2314 (FIG. 2). In step S871, a menu list indicated by the acquired index is acquired by requesting the SIM 2313. In step S873, the next identifier is acquired from the received shortcut string and an index corresponding to the next identifier is acquired from the acquired menu list. Note that the described process is utilized to emulate traversal behavior of MMI operation by a user in background, and a user does not recognize these interactions between the processor 2305, the SIM 2313 and the non-volatile memory 2306 when triggering a SAT shortcut procedure.

Examples are further described in the following. After acquiring a shortcut string “News→Sports” form the non-volatile memory 2306 (step S811), a top-level SAT menu list (the display content related to the top-level SAT menu list may refer to FIG. 6b) is acquired by requesting the SIM 2313, the beginning identifier “News” is acquired from the acquired shortcut string and an index corresponding to “News” is acquired from the top-level menu list (step S813). After determining that the acquired identifier is not the last one (step S831), a menu list indicated by the index (the display content related to the acquired menu list may refer to FIG. 6e) is acquired by requesting the SIM 2313 (step S871) and then, the next identifier “Sports” is acquired from the shortcut string and an index corresponding to “Sports” is acquired from the acquired menu list (step S873). After determining that the acquired identifier is the last one (step S831) and the acquired index indicates SAT commands (step S851), a series of SAT commands indicated by the acquired index are issued to a SAT application of a remote server by requesting the SIM 2313 in order to retrieve sport news published by the SAT application and display the retrieved sport news on the display device 2314.

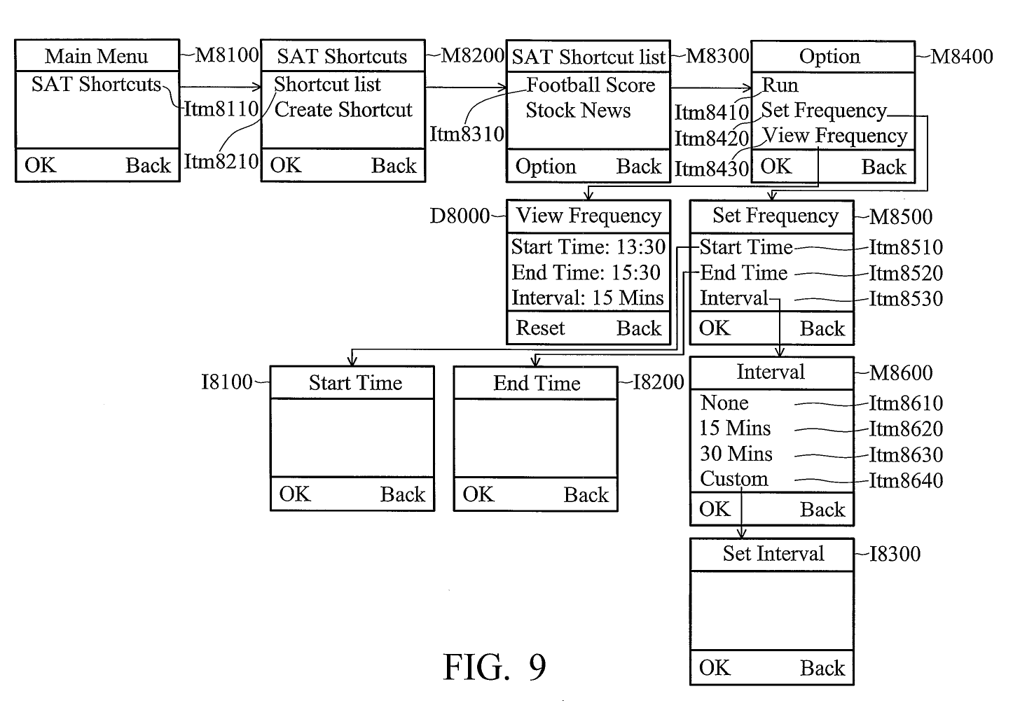

FIG. 9 is a diagram illustrating the menu structure for configuring and periodically acquiring real-time football scores. Initially, a main menu M8100 contains one menu item labeled “SAT Shortcuts” Itm8110. After detecting that the menu item Itm8110 is selected to configure or execute SAT shortcuts, a SAT shortcuts menu M8200 comprising a menu item labeled “Shortcut list” Itm8210 is displayed. When detecting that the menu item Itm8210 is selected to acquire all created SAT shortcuts, a SAT shortcuts list menu M8300 containing two menu items respectively relating to two created SAT shortcuts is displayed. One menu item labeled “Football Score” Itm8310 relates to a created SAT shortcut to configure or execute a VAS service provided by the SAT application 131 of the server 13 (FIG. 1). The VAS service can periodically acquire real-time football scores from the SAT application 131 (FIG. 1) run by the server 13. After detecting that the menu item M8300 is selected, an option menu M8400 containing three menu items respectively labeled “Run” Itm8410, “Set Frequency” Itm8420, and “View Frequency” Itm8430 is displayed. After detecting that the menu item Itm8410 is selected, the processor 2305 (FIG. 2) periodically issues SAT commands to the SAT application 131 to acquire real-time football scores every predetermined interval. FIG. 9 is a sequence diagram illustrating periodically acquiring real-time football scores from the server 13. After a predefined interval has elapsed from the prior request, SAT commands are issued to the SAT application 131 to request real-time football scores. Subsequently, the server 13 responds to the mobile phone 11 with current football scores.

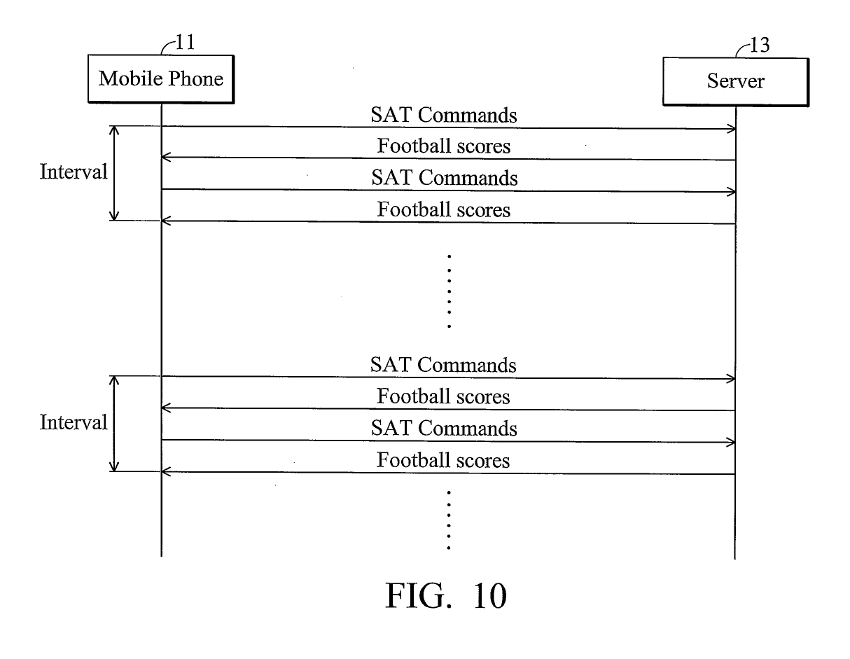

Referring to FIG. 10, after detecting that the menu item Itm8430 is selected, pre-configured VAS values, such as start time, end time, and interval, are displayed in a dialog box D8000. After detecting that the menu item Itm8420 is selected, a set frequency menu M8500 containing three menu items respectively labeled “Start Time” Itm8510, “End Time” Itm8520, and “Interval” Itm8530 is displayed. After detecting that the menu item Itm8510 is selected, an input box 18100 is displayed for input of a start time, where the start time indicates an instant to start real-time football score acquisition. After detecting that the menu item Itm8520 is selected, an input box 18200 is displayed for input of an end time, where the end time indicates when to terminate real-time football score acquisition. The input start time and end time of the input boxes 18100 and 18200 are stored in the non-volatile memory 2306. After detecting that the menu item Itm8530 is selected, an interval menu M8600 containing four menu items respectively labeled “None” Itm8610, “15 Mins” Itm8620, “30 Mins” Itm8630, and “Custom” Itm8640 is displayed. After detecting that the menu item Itm8610 is selected, information regarding that the interval is not set is stored in the non-volatile memory 2306, thereby enabling real-time football scores to be acquired at only one time upon reaching the predefined start time. After detecting that the menu item Itm8620 is selected, information regarding that the interval is set to fifteen minutes is stored in the non-volatile memory 2306, thereby enabling real-time football scores to be periodically acquired every fifteen minutes between the predefined start time and end time. After detecting that the menu item Itm8630 is selected, information regarding that the interval is set to thirty minutes is stored in the non-volatile memory 2306, thereby enabling real-time football scores to be periodically acquired every thirty minutes between the predefined start time and end time. After detecting that the menu item Itm8640 is selected, an input box 18300 is displayed for input of an interval. The input interval of the input box 18300 is stored in the non-volatile memory 2306, thereby enabling real-time football scores to be periodically acquired every the input interval between the predefined start time and end time.

Methods for SAT management, or certain aspects or portions thereof, may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a DVD recorder or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, the machine becomes an apparatus for practicing the invention. When implemented on a general-purpose processor, the program codes combine with the processor to provide a unique apparatus that operate analogously to specific logic circuits.

Certain terms are used throughout the description and claims to refer to particular system components. As one skilled in the art will appreciate, consumer electronic equipment manufacturers may refer to a component by different names. This document does not intend to distinguish between components that differ in name but not function.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A method for subscriber identity module (SIM) application toolkit (SAT) management, performed by a processing unit of a mobile station, the method comprising:
creating a SAT shortcut to a SAT final node, or to a sub-menu comprising the SAT final node;
requesting a value-added service (VAS) provided by a SAT application of a remote server when selecting the SAT shortcut to the SAT final node; and
displaying the sub-menu when selecting the SAT shortcut to the sub-menu.

2. The method as claimed in claim 1 wherein the VAS is requested by issuing at least one SAT command to the SAT application of the remote server.

3. The method as claimed in claim 2 wherein the SAT command is stored in a SIM of the mobile station.

4. The method as claimed in claim 1 further comprising:
providing a man-machine interface (MMI) comprising a SAT shortcut creation menu comprising the sub-menu;
creating the SAT shortcut to the final node when detecting an MMI operation signal indicating that the final node is mapped to a SAT shortcut; and
creating the SAT shortcut to the sub-menu when detecting an MMI operation signal indicating that the sub-menu is mapped to a SAT shortcut.

5. The method as claimed in claim 4 further comprising traversing the provided SAT shortcut creation menu.

6. The method as claimed in claim 5 wherein the traversing step further comprises:
requesting an item type of a menu item when browsing the menu item of the SAT shortcut;
generating at least two soft keys respectively for SAT shortcut generation, and acquisition of a sub-menu relating to the menu item when the item type of the menu item is a list; and
generating at least one soft key for SAT shortcut generation when the item type of the menu item is a final node.

7. The method as claimed in claim 6 wherein the item type of the menu item is acquired from a SIM of the mobile station.

8. The method as claimed in claim 1 wherein the creating step further comprises:
generating and inserting a menu item for the created SAT shortcut into a shortcut list menu collecting a plurality of SAT shortcuts,
whereby VAS requests, or the sub-menu to be displayed when the menu item of the shortcut list is selected is enabled.

9. The method as claimed in claim 1 wherein the creating step further comprises:
mapping the created shortcut to a hard key on a keypad of the mobile station,
whereby VAS requests, or the sub-menu to be displayed when presenting an idle screen on a display device of the mobile station, and detecting a keystroke signal of the mapped hard key on the keypad.

10. The method as claimed in claim 1 wherein at least one SAT command is periodically issued to the SAT application in order to acquire information when selecting the SAT shortcut to the SAT final node.

11. An apparatus for subscriber identity module (SIM) application toolkit (SAT) management, comprising:
a display device; and
a processing unit, coupling to the display device, creating a SAT shortcut to a SAT final node, or to a sub-menu comprising the SAT final node, requesting a value-added service (VAS) provided by a SAT application of a remote server when selecting the SAT shortcut to the SAT final node, and displaying the sub-menu on the display device when selecting the SAT shortcut to the sub-menu.

12. The apparatus as claimed in claim 11 wherein the VAS is requested by issuing at least one SAT command to the SAT application of the remote server.

13. The apparatus as claimed in claim 12 further comprising a SIM, wherein the SAT command is stored in the SIM.

14. The apparatus as claimed in claim 11 wherein the processing unit provides a man-machine interface (MMI) comprising a SAT shortcut creation menu comprising the sub-menu, creates the SAT shortcut to the final node when detecting an MMI operation signal indicating that the final node is mapped to a SAT shortcut, and creates the SAT shortcut to the sub-menu when detecting an MMI operation signal indicating that the sub-menu is mapped to a SAT shortcut.

15. The apparatus as claimed in claim 14 wherein the processing unit traverses the provided SAT shortcut creation menu.

16. The apparatus as claimed in claim 15 wherein the processing unit requests an item type of a menu item when browsing the menu item of the SAT shortcut, generates at least two soft keys respectively for SAT shortcut generation, and acquisition of a sub-menu relating to the menu item when the item type of the menu item is a list, and generates at least one soft key for SAT shortcut generation when the item type of the menu item is a final node.

17. The apparatus as claimed in claim 16 further comprising a SIM, wherein the processing unit requests the item type of the menu item to the SIM.

18. The apparatus as claimed in claim 11 wherein the processing unit generates and inserts a menu item for the created SAT shortcut into a shortcut list menu collecting a plurality of SAT shortcuts, whereby VAS requests, or the sub-menu to be displayed when the menu item of the shortcut list is selected is enabled.

19. The apparatus as claimed in claim 11 further comprising a keypad comprising a hard key, wherein the processing unit maps the created shortcut to the hard key, whereby VAS requests, or the sub-menu to be displayed when presenting an idle screen on the display device is enabled, and detecting a keystroke signal of the mapped hard key on the keypad.

20. The apparatus as claimed in claim 11 wherein the processing unit periodically issues at least one SAT command to the SAT application in order to acquire information when selecting the SAT shortcut to the SAT final node.

21. A method for subscriber identity module (SIM) application toolkit (SAT) management, performed by a processing unit of a mobile station, the method comprising:
receiving a menu traversal path; and
performing a SAT shortcut triggering procedure emulating traversal behavior of man-machine interface (MMI) operation corresponding to the menu traversal path in background in order to issue a SAT command to a SAT application of a remote server to acquire a particular value-added service (VAS), or display a menu list.

22. The method as claimed in claim 21 wherein the menu traversal path is received when detecting that a hard key corresponding to the menu traversal path is pressed upon display of an idle screen.

23. The method as claimed in claim 21 wherein the menu traversal path comprises a plurality of identifiers, and the SAT shortcut triggering procedure comprises:
acquiring the last identifier from the menu traversal path;
determining whether the last identifier corresponds to the SAT command or the menu list;
issuing the SAT command to the SAT application of the remote server to acquire the VAS when the last identifier corresponds to the SAT command; and
acquiring and displaying the menu list when the last identifier corresponds to the menu list.

24. The method as claimed in claim 23 wherein the SAT shortcut triggering procedure comprises:
acquiring an index corresponding to the last identifier; and
determining whether the acquired index corresponds to the SAT command or the menu list.

25. The method as claimed in claim 21 wherein the menu traversal path comprises a plurality of identifiers, and the SAT shortcut triggering procedure comprises:
acquiring a first menu list comprising a plurality of first identifiers each with an index;
acquiring a second identifier other than the last identifier from the menu traversal path;
retrieving an index of the acquired second identifier from the first menu list; and
acquiring a second menu list corresponding to the retrieved index.

26. An apparatus for subscriber identity module (SIM) application toolkit (SAT) management, comprising:
a SIM;
a nonvolatile memory storing a menu traversal path; and
a processing unit, coupling to the nonvolatile memory, and performing a SAT shortcut triggering procedure emulating traversal behavior of man-machine interface (MMI) operation corresponding to the menu traversal path in background in order to issue a SAT command to a SAT application of a remote server to acquire a particular value-added service (VAS) via the SIM, or acquire a menu list from the SIM and display the menu list.

27. The apparatus as claimed in claim 26 further comprising a keypad comprising a hard key corresponding to the menu traversal path, and a display device, wherein the processing unit acquires the menu traversal path from the nonvolatile memory when detecting that the hard key is pressed upon display of an idle screen on the display device.

28. The apparatus as claimed in claim 26 wherein the menu traversal path comprises a plurality of identifiers, and the processing unit acquires the last identifier from the menu traversal path, determines whether the last identifier corresponds to the SAT command or the menu list, issues the SAT command to the SAT application of the remote server to acquire the VAS by requesting the SIM when the last identifier corresponds to the SAT command, acquires the menu list by requesting the SIM and displays the menu list when the last identifier corresponds to the menu list.

29. The apparatus as claimed in claim 28 wherein the processing unit acquires an index corresponding to the last identifier, and determines whether the acquired index corresponds to the SAT command or the menu list.

30. The apparatus as claimed in claim 26 wherein the menu traversal path comprises a plurality of identifiers, and the processing unit acquires a first menu list comprising a plurality of first identifiers each with an index by requesting the SIM, acquires a second identifier other than the last identifier from the menu traversal path, retrieves an index of the acquired second identifier from the first menu list and acquires a second menu list corresponding to the retrieved index.
